(19) United States
(12) Patent Application Publication
(10) Pub. No.: US 2002/0107015 A1
(43) Pub. Date: Aug. 8, 2002

(54) RADIO RECEIVER WITH A RECORDING UNIT AND CONNECTED TELEPHONE UNIT FOR INCOMING RADIO SIGNALS

(76) Inventor: THOMAS MENZEL, HOLLE (DE)

Correspondence Address: STRIKER STRIKER & STENBY, 103 EAST NECK ROAD, HUNTINGTON, NY, 11743

(21) Appl. No.: 09/284,159

(22) PCT Filed: Oct. 14, 1997
(86) PCT No.: PCT/DE97/02342

(30) Foreign Application Priority Data
Oct. 15, 1996 (DE) 196 42 524.7

(51) Int. Cl. H04Q 7/20

(52) U.S. Cl. 455/426; 455/66

(57) ABSTRACT

A radio receiver (1) with a recording unit (5) is proposed that serves to record incoming radio signals, in particular traffic radio signals. The radio receiver (1) has a low-frequency amplifier (10), which is connected to the recording unit (5) and to which an audio playback unit (15) is connected. The recording unit (5) is connected to a speech device (20, 25), preferably a hands-free microphone (20) and/or a handset (25) of a telephone unit (30). An announcement text can be stored in memory in the recording unit (5) via the speech device (20, 25). The recording unit (5) outputs a stored announcement text after receiving a prompting signal.

### PRIOR ART

The invention is based on a radio receiver with a recording unit as generically defined by the preamble to the main claim. From German Patent Disclosure DE 37 21 279 A1, a circuit arrangement for radio receivers is known in which a memory unit is provided, which processes information intercepted by the radio receiver, stores them digitally in memory, and repeats them on demand arbitrarily often.

### ADVANTAGES OF THE INVENTION

The radio receiver of the invention having the characteristics of the main claim has the advantage over the prior art that the recording unit serves not only to record radio signals but also to record an announcement text that can be input to a speech device. In this way, the recording unit can be used in more versatile ways, so that for storing an announcement text no separate memory device is needed, and in this way space, expense and effort can be saved.

By means of the provisions recited in the dependent claims, advantageous refinements of and improvements to the radio receiver defined by the main claim are possible.

An especially advantageous aspect is the integration of a telephone unit with the radio receiver; the telephone unit is connected to the recording unit and upon an incoming call sends a prompting signal to the recording unit if the call is not answered; after receiving the prompting signal, the recording unit transmits the announcement text to the forwarding to the calling subscriber. In this way, the recording unit can also be used as a telephone answering machine, but then requires no separate memory unit of the kind required by the mobile box in the digital radiotelephone network for embodying the telephone unit as a mobile phone, so that not only space, cost and effort but also fees can be saved by not using such a mobile box.

Another especially advantageous aspect is the at least partial storage in memory of conversations carried out with the telephone unit in the recording unit. This increases the versatility of the recording unit further, at no significant additional expense.

Another advantage is the delivery of the radio signals to the recording unit via the telephone unit; digitizing and data compression of the radio signals delivered to the recording unit are thereby made possible in the telephone unit. In this way, no additional devices for digitization and data compression of the radio signals to be delivered to the recording unit are needed, so that once again effort, space and expense are saved. Because of the data compression, advantageously more information can be stored in memory in the recording unit.

Further advantageous space savings are obtained by integrating the recording unit with the telephone unit.

The joint use of the audio playback unit of the radio receiver to play back the memory contents of the recording unit is also advantageous. In this way, no separate audio playback unit is needed, and once again effort, space and cost are saved.

### DRAWINGS

Exemplary embodiments of the invention are shown in the drawing and described in further detail in the ensuing description.

FIG. 1 shows a radio receiver with a telephone unit and a separate recording unit, and

FIG. 2 shows a radio receiver with a telephone unit into which a recording unit is integrated.

### DESCRIPTION OF THE EXEMPLARY EMBODIMENT

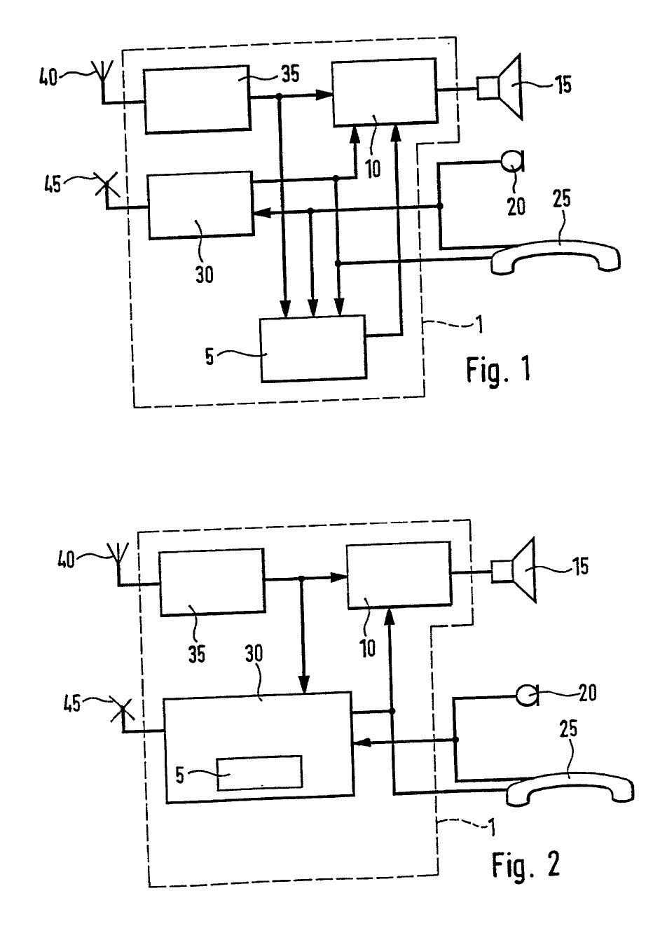

In FIG. 1, reference numeral 1 designates a radio receiver, which includes a radio module 35, a telephone unit 30, a recording unit 5, and a low-frequency amplifier 10. Radio signals are delivered to the radio module 35 via a receiving antenna 40. After the radio signals received are processed and converted into low-frequency signals in the radio module 35, the low-frequency radio signals are forwarded directly via the low-frequency amplifier 10 to an audio playback unit 15, for instance comprising at least one speaker, and/or are delivered to the recording unit 5. The radio signals delivered to the recording unit 5 are primarily traffic radio signals which are already detected in the radio module 35. However, it is also conceivable for other radio signals not containing any traffic information to be forwarded from the radio module 35 to the recording unit 5. Before the radio signals are stored in memory in the recording unit 5, they need to be digitized, unless digital radio signals have already been received via the receiving antenna. A corresponding analog to digital conversion can then be done for instance in the recording unit 5, the radio module 35, or between the radio module 35 and the recording unit 5. Via a transmitting and receiving antenna 45 connected to the telephone unit 30, preferably digital telephone signals are delivered to the telephone unit 30. If analog telephone signals are delivered, then an analog to digital conversion of the received telephone data is also performed in the telephone unit 30. The digital or digitized telephone signals are subjected to data compression in the telephone unit 30 and are then forwarded via the low-frequency amplifier 10 to the audio playback unit 15 and/or delivered to the recording unit 5 and/or output to a handset 25 for acoustical playback. The handset 25 is also connected to the recording unit 5, so that after digitizing of audio or speech signals input into the handset 25, the recording unit 5, or between the handset 25 and the recording unit 5, these audio or speech signals can be stored in memory in the recording unit 5, for instance in the form of an announcement text or as part of a telephone conversation. In addition, audio or speech signals can also be output from the handset 25 directly to the telephone unit 30, optionally digitized, and then broadcast via the transmitting and receiving antenna 45. For inputting audio or speech signals, a hands-free microphone 20 is analogously suitable; it is likewise connected to the telephone unit 30, the recording unit 5, and the handset 25. Finally, the recording unit 5 is connected to the low-frequency amplifier 10; before signals are output to the low-frequency amplifier 10, digital/analog conversion of the signals to be output is done, preferably in the recording unit 5.

In the exemplary embodiment described, the recording unit 5 can be used as a memory for traffic announcements, as a telephone answering machine, and for recording telephone conversations. In use as a telephone answering machine, an announcement text is stored in memory, after digitization, in the recording unit 5 via the hands-free microphone 20 and/or the microphone of the handset 25. When a call comes into the telephone unit 30, the telephone unit sends a prompting signal to the recording unit 5 if the incoming call is not answered. Once the prompting signal is received, the recording unit 5 then outputs the announcement text to the telephone unit 30, and from there this announcement text is then forwarded to the calling subscriber via the transmitting and receiving antenna and a corresponding telecommunications network. Data stored in memory in the recording unit 5 can be played back via the audio playback unit 15.

In FIG. 2, a further exemplary embodiment of the invention is shown; the same component groups as in FIG. 1 are provided and are each provided with the same reference numerals, but they differ in part in their arrangement from the exemplary embodiment shown in FIG. 1. In FIG. 2, the recording unit 5 is integrated with the telephone unit 30, and the radio signals are thus delivered to the recording unit 5 via the telephone unit 30. Furthermore, because of the integration of the recording unit 5 with the telephone unit 30, the connecting lines between the telephone unit 30 and the recording unit 5 can be omitted, since these lead lines are now embodied inside the telephone unit 30. The function is the same as in FIG. 1, but some improvements can be attained. For instance, an analog/digital converter provided in the telephone unit 30 can be jointly used to digitize received telephone signals and/or audio or speech signals input via the hands-free microphone 20 and/or the microphone of the handset 25, and also to digitize radio signals. In the same way, devices for data compression in the telephone unit 30 for received telephone signals and/or audio or speech signals from the hands-free microphone 20 and/or the microphone of the handset 25 can also be jointly used for the radio signals to be stored in memory. In this way, no additional analog/digital converter is needed for the radio signals to be stored in memory, and as a result of the data compression of the radio signals to be stored as well, more information can be stored in memory in the recording unit 5. In the embodiment of FIG. 1, conversely, the capability of storing radio signals, especially traffic radio information, in memory during a telephone call without having to access the telephone signal processing or interrupt a telephone call is advantageous, because in the exemplary embodiment of FIG. 1 radio and telephone signals are not jointly processed digitally.

In a further exemplary embodiment, not shown, it is also possible not to integrate the telephone unit 30 with the radio receiver 1 but rather connect it externally to the radio receiver 1. Then the recording unit 5 of the exemplary embodiment of FIG. 1 can remain in the radio receiver 1 or, as in the exemplary embodiment of FIG. 2, be integrated with the telephone unit 30. The storage of radio and telephone signals in memory is then done in the manner described above.

1. A radio receiver (1) with a recording unit (5) for incoming radio signals, in particular traffic radio signals, and a low-frequency amplifier (10), connected to the recording unit (5) and to which an audio playback unit (15) is connected, characterized in that the recording unit (5) is connected to a speech device (20, 25), preferably a hands-free microphone (20) and/or a handset (25) of a telephone unit (30), and that an announcement text can be stored in memory in the recording unit (5) via the speech device (20, 25).

2. The radio receiver (1) of claim 1, characterized in that the recording unit (5) outputs a stored announcement text after receiving a prompting signal.

3. The radio receiver (1) of claim 1 or 2, characterized in that the radio receiver (1) includes a telephone unit (30), that the telephone unit (30) is connected to the recording unit (5), that the telephone unit (30), upon an incoming call, outputs a prompting signal to the recording unit (5) if the call is not answered, and that the recording unit (5) after receiving the prompting signal transmits the announcement text to the telephone unit (30) for further transmission to the calling subscriber.

4. The radio receiver (1) of claim 3, characterized in that conversations conducted with the telephone unit (30) can be at least partly stored in memory in the recording unit (5).

5. The radio receiver (1) of claim 3 or 4, characterized in that the radio signals are delivered to the recording unit (5) via the telephone unit (30).

6. The radio receiver (1) of claim 5, characterized in that digitizing of signals delivered to the recording unit (5), in particular delivered radio signals, is done in the telephone unit (30).

7. The radio receiver (1) of claim 6, characterized in that data compression of signals delivered by the recording unit (5), in particular of delivered radio signals, is done in the telephone unit (30).

8. The radio receiver (1) of one of claims 3-7, characterized in that the recording unit (5) is integrated into the telephone unit (30).

9. The radio receiver (1) of one of the foregoing claims, characterized in that the memory contents of the recording unit (5) can be played back at the audio playback unit (15) via the low-frequency amplifier (10).
